(19) United States
(12) Patent Application Publication
(10) Pub. No.: US 2023/0274155 A1
(43) Pub. Date: Aug. 31, 2023

(54) SYSTEMS AND METHODS FOR EMPATHY-BASED MACHINE LEARNING

(71) Applicant: ROYAL BANK OF CANADA, Toronto (CA)

(72) Inventors: Gurinder MAROK, Mississauga (CA); Ehsan AMJADIAN, Toronto (CA)

(21) Appl. No.: 18/115,731

(22) Filed: Feb. 28, 2023

Related U.S. Application Data
(60) Provisional application No. 63/314,896, filed on Feb. 28, 2022.

(51) Int. Cl. G06N 3/09; G06N 3/045

(52) U.S. Cl. CPC G06N 3/09; G06N 3/045

(57) ABSTRACT

A computing system configured to generate empathy-based machine-learning outputs, which, for example, can include notifications, automatic service delivery, payments, among others. The system receives as inputs a first set of data sets representative of historical behaviour through tracked interactions, a second set of data sets representative of circumstantial knowledge (e.g., environmental factors, such as weather), and a set of empathy model weights from one or more machine learning models that are configured to model one or more empathy consideration components (e.g., curiosity, preconceptions, inspirations, direct experiences, listened experiences, imagination, among others). Corresponding methods and non-transitory computer readable media are contemplated.

### CROSS-REFERENCE

This application is a non-provisional of, and claims all benefit, including priority to, U.S. Application No. 63/314,896, filed 28 Feb. 2022, entitled “SYSTEMS AND METHODS FOR EMPATHY-BASED MACHINE LEARNING”. The priority application is incorporated by reference in its entirety.

### FIELD

Embodiments of the present disclosure generally relate to the field of machine learning, and more specifically, embodiments relate to devices, systems and methods for empathy-based machine learning.

### INTRODUCTION

Machine learning approaches for generating insights by organizations are often directed to promoting a behavioural outcome that may not be well aligned with an individual's interest. For example, advertising networks may be seeking to influence a purchasing behaviour such that a specific product is selected over a set of similar competitor products. However, such approaches do not take into consideration the empathetic situational aspects of the individual, and accordingly, the insights may have limited uptake or acceptance by the individual.

This is especially pertinent in respect of connectivity enabled using Internet-of-Things (IoT) technology, which is an emerging channel that connects all things, facilitating the movement of high fidelity data into emerging ecosystems. Instead of selling products, rather, organizations seek to promote lifestyle through subscriptions and services offered in IoT ecosystems. As individuals have limited attention spans and ability to multitask, it becomes increasingly important to have accuracy and convenience in service provisioning. For example, services can be provided “in-path” in so far as possible with higher fidelity data from multiple sources fueling real-time contextualized insights such that an individual is provided with relevant, timely, and useful insights.

When the generated insights do not take into account the emotional or empathetic state of an individual, the generated insights or how they are presented can result in annoyances for the individual.

### SUMMARY

A computational approach is proposed that is directed to a computing system configured to generate empathy-based machine-learning outputs, which, for example, can include notifications, automatic service delivery, payments, among others. The approach is an improved approach that specifically uses computational machine learning architectures (e.g., neural networks) that work together to modify the operation of computational processes. In particular, the approach adds, as an input signal, a computational representation based at least on tracked empathetic or empathy-based factors relating to an individual that can then be used alongside other computational decision making to effectively bias the decision making towards shifted outcomes that are modified based on the tracked empathy-driven factors.

The approach effectively transforms non-empathy-based machine learning models through the addition of the empathy-based signal input to yield a more robust decision making framework for complex, real-time decision making, such as determining notification timing (if a plurality of notification timing is available), notification selection (if a plurality of notification choices are available), and graphical user interface presentment options associated with the notification (if a plurality of user interface presentment variations are available, automatically controlling the display characteristics of icons), among others.

While the system adapted to implement the computational approach increases complexity and cost as additional machine learning data structures are required to be maintained (e.g., increasing infrastructure requirements), a number of practical implementation variations are contemplated and proposed to reduce the overall computational burden associated with the continuous computation and generation of the empathy-based modelling. A potential technical benefit of the system is that it will increase relevance and affinity for a particular user, which may drive a more robust usage model that would not be possible without empathy-based machine learning models (e.g., empathy-based circuits).

The system receives as inputs a first set of data sets representative of historical behaviour (e.g., past purchasing behaviour, browsing behaviour), a second set of data sets representative of circumstantial knowledge (e.g., environmental factors, such as weather), and a set of empathy model weights from one or more machine learning models that are configured to model one or more empathy consideration components (e.g., curiosity, preconceptions, inspirations, direct experiences, listened experiences, imagination, among others).

The one or more machine learning models are maintained and updated over time, and for example, can include neural networks or deep learning machine learning model architectures comprised of interconnected computing nodes which can be traversed to generate computational outputs, such as logits or prediction values. The interconnected computing nodes are represented as data objects having tune-able interconnection weights, which when traversed, represent a transfer function that attempts to approximate a particular ground truth. The interconnection weights are tuned over time through supervised learning (e.g., using historical behaviour data sets) or reinforcement learning (e.g., in real or near real time based on feedback).

An ensemble-based analysis is conducted by a processor configured to receive as data inputs, tuning matrices storing data representation of weight values from both an empathy-based machine learning mechanism and a circumstantial knowledge-based machine learning mechanism maintaining the corresponding models.

When a new conjecture data object is generated representing a potential notification or an automatic action, the conjecture data object is processed to couple the conjecture data object with a number of circumstantial or empathy based relationships, generated, for example, using predictions from historic behaviour. For example, a new conjecture data object could represent a notification that a vehicle's fuel level is becoming low, and that a certain refuelling station is along or proximate to the path of the individual returning home from work. The conjecture data object could be coupled with prior historical behaviour tracking to identify a set of circumstantial (e.g., weather) or empathy-based variables (e.g., anxiety levels) or factors which have impacted prior similar decisions.

The conjecture data object is then processed using the ensemble-based analysis to analyze the conjecture data object in view of the current situation's empathy-based tuning matrix weights and circumstance-based tuning matrix weights, and an empathy-based conjecture score is generated as an output. The empathy-based conjecture score is utilized to determine an empathic insight output, which, in some embodiments, can include a notification or an automatic action.

In some embodiments, outcome feedback from whether an action was taken in respect of a notification or other types of responses occurred (e.g., notification acknowledged, dismissed, blocked) is tracked, which is then utilized to re-tune the circumstance-based tuning matrix, or the empathy-based tuning matrix and/or their corresponding machine learning models.

In a variation, the amount of privacy and available information may be tune-able by the user (e.g., using a controllable slider or knob) such that the system capabilities can be tuned based on the amount of information that is made available to the system. A trade-off between accuracy and availability of information/privacy is a consideration in the overall effectiveness of the system. However, such a feature is useful to provide user control over the amount of information to be exposed.

In another variation, a “virtual clean room”/trusted execution environment can be utilized to control access information, derivative information, and/or insights, for example, through controlling a data load and a data custodian aspect of any information or query to information stored on a coupled computer-readable storage. The trusted execution environment may operate on a secured/separated environment such that the environment is computationally isolated from other computing components and automatic privacy-enhancing mechanisms are used to enforce what information is available for access in conducting analyses.

In a further embodiment, the empathy-based machine learning models and/or the circumstance-based machine learning models are also hosted on and/or protected by the “virtual clean room”/trusted execution environment such that these models and their underlying interconnections cannot be directly accessed or queried to further enhance the privacy of the individual in respect of machine learning models that seek to emulate particular traits of an individual. In this example, the values and structures of the machine learning models is not accessible and instead, the machine learning models can only be interacted with to generate the specific tuning matrices.

In some embodiments, the system is a plug and play computational mechanism that can be retrofit or otherwise introduced into recommendation/expert systems. For example, the system can receive messages in a queue or buffer from recommendation/expert systems, and be configured to process these messages in determining whether or when the messages should be delivered to the individual.

Example implementation use cases, for example, include aiding decision making in respect of purchasing fuel for an automobile, modifying call center agent workflows, credit provisioning, among others.

As a non-limiting practical example for implementation, the empathy-based approach can be utilized through a set of machine learning mechanisms that interact together to drive decision-making relating to the generation of notifications to a user that are provided contextually and in real-time based on circumstantial characteristics as well as tracked behaviors and preferences of the user over time.

The empathy-based model can be maintained and persisted on a global user model (e.g., the “oracle” model), and can include a set of empathy-based models (e.g., empathy-based circuits), which can be based on one or more empathy-based models that store a set of weights and scalars for a number of models. These models can be tracked for various empathy qualities in a human, which may or may not be mutually exclusive, such as having a set of cooperating models specifically for tracking a human's proclivity to exploring new pathways, another for tracking the human's openness to listening to information be presented before them, another tracking the human's tendency to follow prior direct experiences, among others. These models can be trained on a per-user basis, and once trained, can be continuously updated, periodically updated, or permanently set, depending on the embodiment.

Each of these models can be initialized to have pre-defined weightings or random weightings, and as part of the training process, these weightings can be updated and refined based on iterating the model to optimize a loss function using the person's past activities and provided preferences as ground truth for training. The oracle model can be omnipresent such that it is associated with the person across all channels of interaction that are coupled to the system. As described further herein, these channels can include, among others, video feeds, chat sessions, online browsing sessions, and extracted data can be used for updating the models over time, synchronously or asynchronously.

An outcome from training can include a representative set of scalars for machine learning parameters that together define the latent or hypothesis space for a particular empathy-based aspect of a person's personality (e.g., a person's persona), and these values or vectors can then be used as a simplified representation for downstream usage. Accordingly, the models, once trained, represent the person's base tendencies (e.g., Rohin is a naturally a very curious individual who enjoys trying new things, but has a tendency to prefer relying on his direct experiences rather than listening to information provided by others).

Rohin's base empathy is now modelled and stored as a computer-based representation that is can be used for further individualized machine learning tuning. When Rohin first encounters the system, the “persona” model can be initialized based on his demographic factors. However, as Rohin interacts more with the system in various channels, the profile shifts and becomes more nuanced through training (e.g., Rohin's personality is influenced because he is a programmer, woodworker—although the system does not have necessarily have these classifications expressly coded for, his preferences and personality features begin to be reflected in the machine learning weightings over time). The weights are continually tuned and the profile shifts as a result of the tuning. A benefit of this approach is that, compared to storing large amounts of profile data elements, instead with each tuning, the underlying data can be discarded and the model retains an efficient memory usage.

Inputs for generating Rohin's persona model can, for example, be obtained from tracked records or on-going interactions with external sources, such as chat bot dialogue flows, voice inflections during calls, tracked website interactions or computer input movements. Other information can include Rohin's biological data during these interactions, such as biorhythms, video feeds, etc. These inputs can be provided, for example, as governed by Rohin's express consent for model personalization. A benefit of using models is that is the underlying data is not required to be stored, and thus once the data is used for training, it can be discarded or removed. Further, in a variation, the underlying data for training can be perturbed or noise can be injected to add a level of “fuzz” to the trained models to further reduce a possibility of reverse engineering.

Rohin's models can be updated periodically or as required, for example, whenever data is available. The updates can be conducted asynchronously, for example, in batches after a particular interaction by Rohin with another system, such as a chat bot. Asynchronous updates are useful to preserve limited computational resources during peak periods.

In some embodiments, personas are prioritized for updates, such that certain personas have data structures that are flagged for a higher rate of updates. These can be personas, for example, that are noted to have a higher amount of variability due to a reduced amount of interactions for training (e.g., personas whose data structures have not been sufficiently iterated such that they are still close to the base demographic or base human profile originally used to initialize the model), or personas, for example, that are selected based on a potential propensity to interact with the system or based on other criteria, such as expected overall spend, or a target designated audience depending on a particular service, etc. For example, the system can also be expressly set to prioritize student profiles for updating.

Where there are a plurality of different empathy based models, each of these models can be coupled with a biasing factor that is modifiable based on the specific circumstances upon which one is making a decision in a particular moment in time. These circumstantial factors can include, for example, tracked external characteristics, such as weather (e.g., temperature, precipitation), vehicle speed, among others. These circumstantial considerations are then used to provide inputs that are refined and transformed into biasing weights that modify the weighted contribution from each of the empathy-based models, and the overall contribution of a large number of circumstantial considerations can thus be utilized to transform the computational impact of the empathy-based models. These circumstantial considerations, for example, can also include a specific stage as identified by an orchestration engine of a purchasing or decision journey.

In the example of Rohin's empathy model, it may be that while Rohin is very curious as a base state, when Rohin is in a rush (e.g., as evidenced by his vehicle speed), the model may indicate that he is instead driven very much by direct experience and tunes the empathy model so that the direct experience becomes the dominant empathy model (through modifying the weighted contribution) for Rohin in these circumstances. As another factor for contribution into the overall impact from the empathic model, Rohin may also be more open to exploration when the weather is nice (e.g., temperature >75 degrees Fahrenheit) and it has a corresponding effect on his mood. Both of these factors would then have countervailing effects on the contribution, and a weighted contribution could take into account both of these factors together. This example is simplified, and there can be a large number of factors being considered as part of a practical implementation. As a result of the circumstantial knowledge and thus circumstantial factors available at the time of a machine learning decision being made, a tuning matrix can be generated that changes the bias weights of the empathy-based modelling.

The oracle model can be configured to monitor a system for a conjecture trigger event, where the underlying logical conditions for the conjecture trigger event are met, and the system then begins the process of surfacing a notification.

A machine learning model can be employed as a decision making matrix, for example, using a hypothesis engine, to configure first, whether or when notification should be shown to Rohin, then, for example, the specific content of the notification, and/or how the notification should be surfaced in a way that provides maximized utility for Rohin. Utility and interaction can be measured in terms of feedback to the machine learning model to re-tune various characteristics based on actions taken by Rohin. For example, Rohin interacting (instead of ignoring) with the notification may indicate that a particular method of controlling the user interface was effective, and depending on the specific outcome of the interaction (e.g., uses it positively or dismisses it negatively), that can be used to tune which notification to be shown, or whether a notification should be shown at all (or suppressed).

The decision making matrix can be a machine learning model that takes, as only part of the decision making matrix, the input signal from the empathy-based models, as biased by the weighting factors from a tuning matrix established by circumstantial information.

The approach described herein accordingly provides a computational mechanism to improve relevance and resiliency of computer based decision making as it relates to specific empathy-driven personality aspects of a person.

These factors are computationally useful inputs in tailoring machine outputs and decisions based on modelled personality traits, as opposed to relying only on factual decision making. This is useful, for example, as while the same facts may be true for all people in a particular area (e.g., the temperature is 80 degrees Fahrenheit), each person experiences this differently (e.g., some enjoy the warmth, while for others they begin to have increased anxiety or a decreased level of patience, etc.).

In an alternate variation, instead of being a one way input of the empathic signal into the machine learning framework for orchestrating notifications or other activities by the computing mechanism, the reverse approach is possible, or a two way approach is possible. The empathic models can also be utilized as a filter or controlling mechanism as set by a target audience characteristic as part of a campaign management mechanism to control when certain notifications are shown. For example, a campaign may have a variable set indicating that the offer should only be shown to those personas having data structures indicating that the user is, after biasing based on circumstantial information, is highly open to exploring (e.g., a campaign for a vacation on a sunny beach).

An example practical implementation of the empathic system includes a mobile application or a specially configured vehicle notification system having a graphical user interface. One or more conjecture data objects are loaded having triggers for starting the decision making process for a particular notification or event occurring. The proposed system as described herein controls various parameters of the presentment of the notification, including, for example, controlling aspects around timing of presentation, content of presentation, and/or controllable user interface parameters related to the presentation. These presentation aspects are adapted to combine machine learning models and inputs from the oracle mechanism representative of empathetic considerations for an individual from the individual's pre-trained model, modified in relation to specific circumstantial information obtained proximate to the time of presentation, with an objective of improving relevance and reducing annoyance to the individual through adapting parameters of the presentation based on the modified empathetic state representation as an input signal into a hypothesis engine adapted for machine learning.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is an example architectural diagram illustrative of a system for empathy-based machine learning, according to some embodiments.

FIG. 1B is an example block diagram illustrative of an operative computing ecosystem for the system of FIG. 1A, according to some embodiments.

FIG. 2 is an example equation showing a relation for an empathic insight, according to some embodiments.

FIG. 3 is a computer architecture block schematic diagram showing an example computing architecture that can be utilized to provide a computing ecosystem for the empathic circuits, according to some embodiments.

FIG. 4A is a process diagram illustrative of a method where the empathic circuits are utilized in an automotive context, according to some embodiments.

FIG. 4B is a process diagram illustrative of a method where the empathic circuits obtain feedback for updating empathic circuits in an automotive context, according to some embodiments.

FIG. 5 is an example rendering of a graphical user interface (GUI), according to some embodiments.

FIG. 6 is an example block schematic of a computing system, according to some embodiments.

FIG. 7 is an example computer server for generating empathic insights, according to some embodiments.

FIG. 8 is an example method diagram showing an example process approach for using empathic insights in machine learning, according to some embodiments.

### DETAILED DESCRIPTION

A computational approach is proposed that is directed to a computing system configured to generate empathy-based machine-learning outputs. Empathy-based machine learning is overlooked as a potentially important factor in automatically providing tailored messages or actions. Whether a recommended notification is well received by an individual may be determined through a variety of factors, such as human-centric traits such as curiosity, preconceptions/biases, past experiences, among others, and these traits are not often well grounded in rational behaviour. While a recommendation may be objectively a right course of action in seeking to optimize a rational outcome, an individual may not be in the correct mindset to actively receive the recommendation.

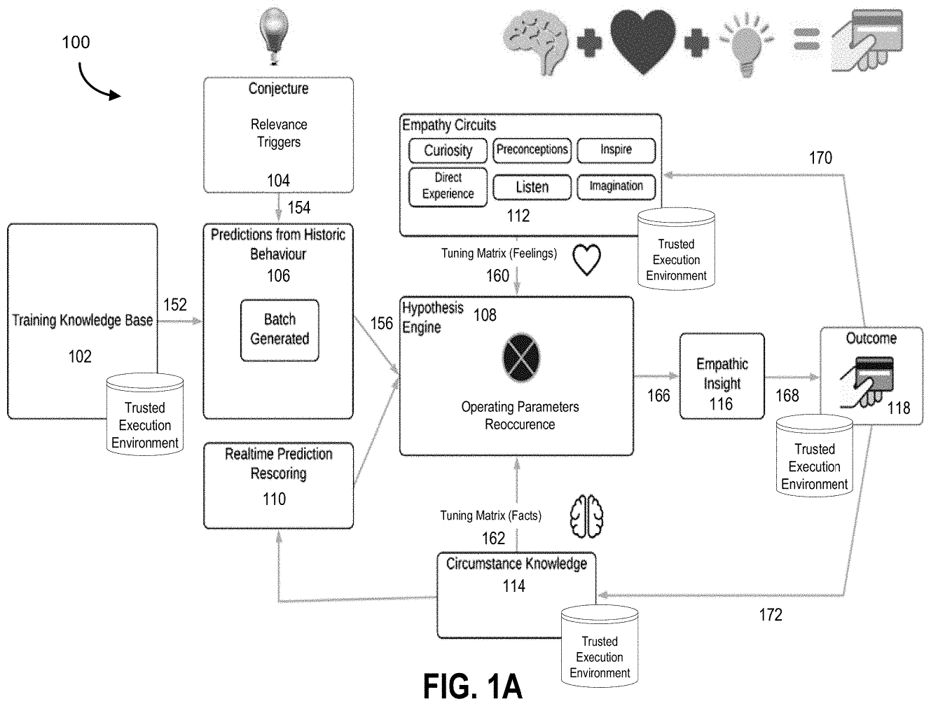

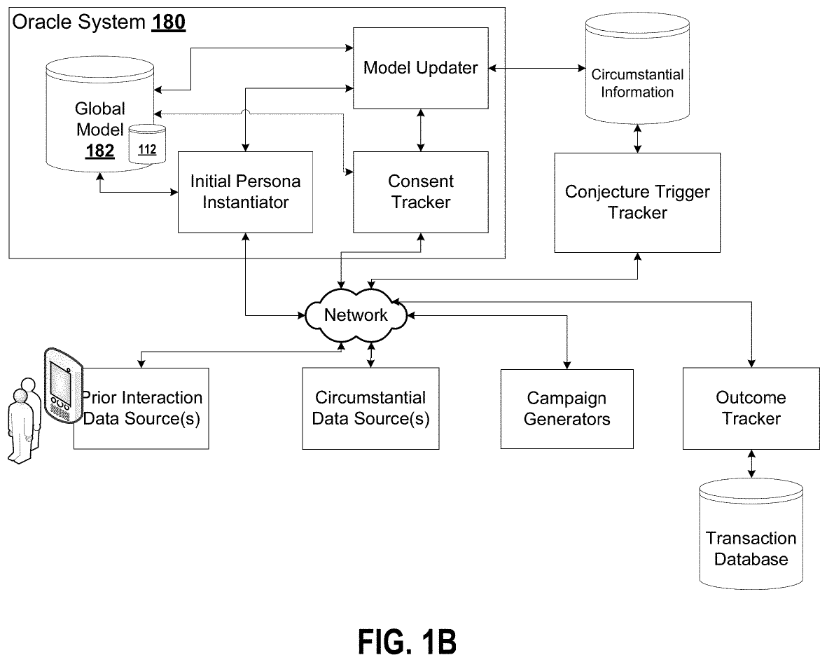

FIG. 1A is an example architectural diagram illustrative of a system for empathy-based machine learning, according to some embodiments. The system 100 is a computerized system that is provided on a plurality of computing devices, including computer processors, servers, and sensory devices. The computer system is configured to receive a set of conjecture data objects representing different notifications or actions and then generate automated determinations of whether the conjecture data object should be surfaced to the individual (e.g., through controlling a notification widget on a corresponding user interface), and in some embodiments, what channels or tuned approach to be used for surfacing the conjecture data object.

The system is especially configured to maintain computational data architectures storing tune-able data objects that represent (1) the individual's empathy-based traits, and (2) circumstantial (e.g., environmental) factors at a point in time for processing the conjecture data object, and then tracking downstream events to determine an outcome action associated with whether a particular action was taken or a conjecture data object was ultimately acted on or discarded.

The system 100 receives as inputs at knowledge base 102, a set of data points 152 including a first set of data sets representative of historical behaviour (e.g., past purchasing behaviour, browsing behaviour), and a second set of data sets representative of circumstantial knowledge (e.g., environmental factors, such as weather).

Conjecture data objects are provided, for example, from an upstream or a downstream computing component and queued for processing at conjecture queue management engine 104, which releases conjecture data objects 154 when the system 100 indicates that it is available to process a new conjecture data object. The conjecture data objects can be loaded periodically in a batch or a continuous pull or push from upstream systems.

In an embodiment, the conjecture data objects are directly provided to the hypothesis engine 108, which is an ensemble based analytic engine configured to apply one or more weightings to generate an ensembleScore value that is ultimately utilized to establish whether an empathic insight 116 should be surfaced. In another embodiment, the conjecture data objects are pre-processed at a pre-processing engine 106 along with prediction data objects 156 generated from historical behaviour data sets such that the conjecture data objects are augmented with metadata representative of weightings based on prior circumstances that were tracked for assessing whether similar conjectures were positively, negatively, or neutrally received by the individual. For example, these circumstantial data elements may include fields associated with weather, time of day, geolocation, among others. To reduce computational load, in some embodiments, the associating of metadata is conducted in a batch generation process. In some embodiments, pre-processing engine 106 is configured to operate in concert with a real time prediction rescoring engine 110 such that weightings associated with newly received feedback can be used to re-tune the weightings of the metadata of the prediction data objects 156, ultimately modifying the metadata tagged to incoming conjecture data objects from 104.

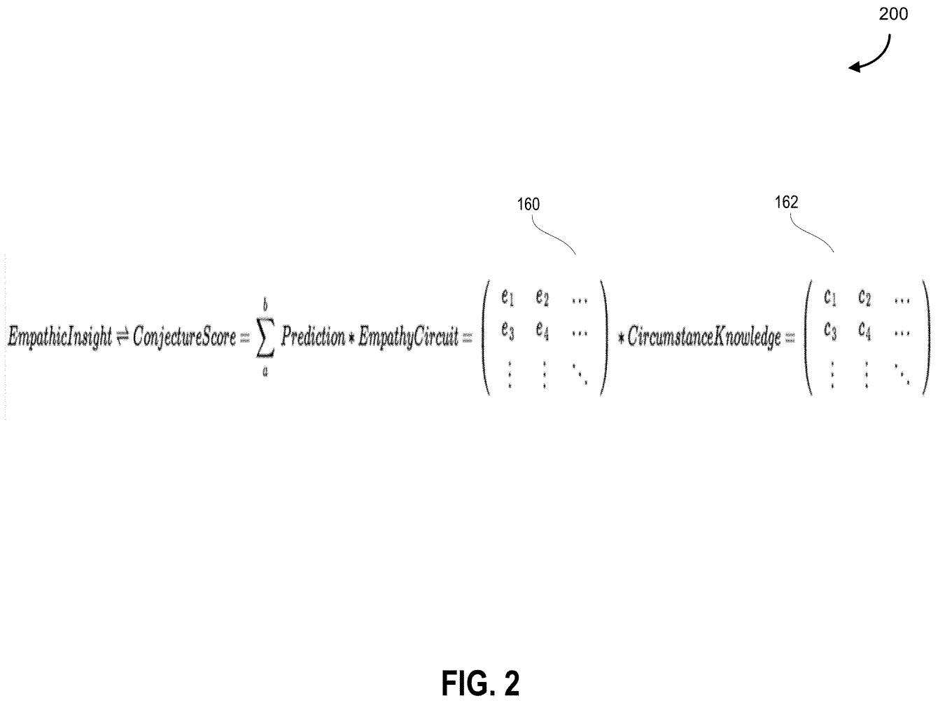

The hypothesis engine 108 is configured to generate prediction or decision determination values based on an ensemble based analysis 200, shown, for example, at FIG. 2, which weighs outputs from other systems, aggregates insights, and generates a computer-based decision on whether the system should act, and in some embodiments, selecting the channel or approach in which the system will act assuming it should act (e.g., phone message, email notification, text notification). In some embodiments, heuristic approaches are utilized by the hypothesis engine 108 to limit the number of dimensions of analysis, for example, where the hypothesis engine 108 operates with limited resources, among others. Approaches to limit the number of dimensions of analysis can include ranked weightings, principal component analysis, among others.

The empathy circuits 112 are a series of machine learning models that are ultimately utilized to establish and maintain a tuning matrix 160 having a set of empathy model weights that are updated over time. The one or more machine learning models of the empathy circuits 112 are configured to model one or more empathy consideration components (e.g., curiosity, preconceptions, inspirations, direct experiences, listened experiences, imagination, among others), and return, at a particular point in time, the tuning matrix 160 that can then be used by the hypothesis engine 108 in generating scores for decision making in relation to empathic insights 116.

The one or more machine learning models of the empathy circuits 112 are maintained and updated over time, and for example, can include neural networks or deep learning machine learning model architectures comprised of interconnected computing nodes which can be traversed to generate computational outputs, such as logits or prediction values. In some embodiments, gamification strategies may be used as a means to implement empathy circuits 112. Particularly, in some embodiments, a developed “Game of Life”, for instance, may be used for a machine to play/train against, and through this process, mimic empathy. The interconnected computing nodes are represented as data objects having tune-able interconnection weights, which when traversed, represent a transfer function that attempts to approximate a particular ground truth. The interconnection weights are tuned over time through supervised learning (e.g., using historical behaviour data sets) or reinforcement learning (e.g., in real or near real time based on feedback).

In some embodiments, the empathy circuits 112 are neural networks that are adapted to generate a classification output directed to a particular persona or personas that are classified for the individual. Each of the empathy aspects can be mapped to a separate persona or a same persona, depending on the embodiment, and the use of personas as classification tools may aid in simplifying and reducing the amount of computational processing required in establishing the tuning matrix 160. The personas are updated, when new insights are generated and outcomes are tracked in relation to data sets representative of interactions with the insights.

For example, if an insight is generated along with a recommended action, and the action was not taken (e.g., as tracked through inputs or lack thereof on a user interface), the non-taking of the action can be utilized as an input into re-tuning the empathy circuits. The empathy circuits can be configured specifically to track specific human empathy centers, such as curiosity, pre-conceptions, inspirations, prior direct experiences, listening capabilities, imagination, among others. The empathy circuits 112, for example, can be configured with feature sets that model and/or computationally mimic human-type mental structures, such as left and right brain analogies, among others.

Pre-conceptions, for example, can include tracking of different types of biases and prejudice in data sets relating to a user, which can then be utilized as an input for tracking the empathic aspects of a person's psyche. Pre-conceptions can be based, for example, upon a human's tendency to form an opinion or a consideration of before actual experience of the event. Pre-conceptions are not necessarily good or bad; a pre-conception is merely an extrapolation in a human mind to conceive and/or prepare for the unknown. Certain less voluntary aspects of decision making can be based on pre-conceptions, for example, and some individuals prefer to rely upon this decision making route as opposed to a more effortful approach as it may aid in being more decisive in a finite period of time.

Inspirations can be modelled and tracked based on modelling how an individual is mentally stimulated to do or feel a particular thing, and in a computing context, may be modelled or derived from outcome data relating to particular events or data that have relevance and may impact a future decision. For example, if an input data set indicates that the user has searched online videos associated with fitness modelling and then has tracked outcome data indicating laterally connected activities, such as the purchase of healthy foods or protein shakes, there may be additional information available.

As the different empathy circuit model 112 portions tracking different human empathy centers are tracked over a period of time, different weightings can be applied to track an influence of particular model portions in the particular decision making of a person. For example, if a person appears to be particularly driven by curiosity (e.g., the inputs and outcomes suggest a leaning towards exploring unknown or injecting an element of randomness in decision making), the curiosity model may be more heavily weighted in terms of contribution to a particular prediction or classification. This can be manifested, for example, through providing an element of entropy into the insights—e.g., the person is modelled to have a very curious and eclectic taste, so various cuisines, even those not experienced before (or perhaps especially those not experienced before) can be suggested. Conversely, the empathy circuit tracking curiosity might indicate the opposite—for example, if a user is driven by a need for predictability and familiarity, the insights may be tailored towards restaurants that have been experienced before.

Accordingly, the empathy circuits can be tuned over a period of time to track and model various behaviours and preferences of the user such that even circumstantial and less tangible considerations may have an impact on a classification. The empathy circuits 112 are combined with the circumstance knowledge model inputs such that the combination of the two models can be used ultimately to generate tuning matrices 160 and 162 which are provided in a combination to the hypothesis engine 108 as features into an overall processing model for generating a classification output 166, such as an empathic insight 116.

The tuning matrix 162 from the circumstantial knowledge, in some embodiments, is a set of biasing weights that are applied to the empathy circuits 112 to yield a modified tuning matrix 160 from the empathy circuits 112. In this embodiment, the circumstance knowledge 114 is used to tune how the person's empathic features have changed in response to circumstantial changes. For example, for a specific person who is presently in a hot and humid environment (as measured by information provided as circumstance knowledge 114), although the person is naturally curious as a base persona, the person is affected by the heat and humidity and becomes less curious, and this can be reflected in the tuning matrix 162, which changes the relative weights as between different empathy circuit models 112 in arriving at the tuning matrix 160.

Tuning matrix generation for generating tuning matrix 162 can be conducted based on a population wide circumstance knowledge model representing impacts on entire populations or subpopulation demographic groups, and the model can be trained based on circumstance knowledge recorded during or temporally proximate to (e.g., conditions of that day, that part of the day, within +/−1 hour) interactions with mechanisms used to train empathy circuits 112. This approach is simpler than having specific models for each individual, but it has a drawback that not everyone is affected equally.

In another embodiment, the tuning matrix generation for generating tuning matrix 162 can be conducted based on a specific circumstance knowledge model for each person, which can be accessible via a trusted execution environment for that person. This approach is more complex than having a limited set of population or sub-population specific models, but it requires further computational complexity and storage.

The empathic insight 116 is a data structure or a data message representation of a classification output, and in some embodiments, may be transmitted or processed by a downstream processing engine to conduct a downstream event, such as the generation of a recommendation graphical user interface element, such as a list of recommendations rendered on a webpage or a mobile application that the user may be able to selectively action upon, indicate that it is incorrect, or ignore.

In a variation, the empathy circuits are instead or in combination adjustable by the user, through the use of interactive interface elements, such as moveable sliders rendered on a widget bar of a graphical user interface, such that a user is able to modify the influence of each of the empathy circuits in generating predictions. For example, a user seeking to be more curious may raise the curiosity slider, or conversely, a user seeking more routine may reduce the curiosity slider.

The outcome is tracked, for example, through outcome data sets 118 obtained at a point of sale device or other type of payment processing engine. In some embodiments, the outcome is instead tracked through other tracked data sets or user inputs, such as the user's location indicating that the user ultimately did visit a particular restaurant or gas station. Where the outcome data set 118 is obtained at a point of sale device, it can be processed to extract data values relating to the insight and how it was actioned upon by the user (e.g., time elapsed since the insight was surfaced or rendered on a mobile device).

In terms of outcome data sets 118, different levels of outcome data sets 118 are possible with differing levels of tracked data that is then provided back into the system. The outcome data sets can be tuned, for example, so that a user is able to control the level of feedback into the system. In some embodiments, the feedback data sets are provided through a trusted execution environment, which is then configured to securely control and restrict access to the data sets (e.g., so that they can only be used for specific purposes and released or loaded only when a correct encryption key or certificate is presented).

The trusted execution environment can be a physically protected or secured device, or a virtually protected or secured device, such as a computational system that manages an always encrypted database and can only provide or load data for training of machine learning models without direct access to the underlying data sets. In another embodiment, the trusted execution environment, during a loading process, the data can be perturbed or otherwise modified so that while the data is still useful for machine learning training, even in the event of a data breach, the data is difficult or rendered useless for a malicious user.

Similarly, the circumstance knowledge circuits 114 are adapted to track factual information at a particular time, and generate a tuning matrix 162 based on factual information that can be obtained either from data streams from an upstream computing mechanism, or directly from coupled sensors. Circumstantial information can include aspects such as time of day, weather, air pressure, temperature, location of the individual, among others. The circumstance knowledge circuits 114 are adapted to track and maintain similarly a machine learning model tracking weights stored in the tuning matrix 162. The tuning matrices are coupled together by the hypothesis engine 108 as inputs for ultimately generating the empathic insight 116, which is a modified decision for a particular event or notification. As an example, the circumstance knowledge circuits 114 can be adapted and tuned based on the individual's prior responses to empathic recommendations in view of the environmental conditions. These can be tracked, for example, based on sensor data sets or timestamped data that is geolocation coded, such as whether it was raining that day, the fuel level of a gas tank, the time of day, among others. These factors may not be under the direct control of the individual but are happening around the individual.

Feedback loops 170 and 172 are utilized to re-tune the circuits 112 and 114 based on the outcome data, such that tuning matrices and/or underlying model weights can be modified in response to positive or negative feedback (e.g., establishing reward/penalty mechanisms). In some embodiments, the circuits 112 and 114 can also be trained using prior data sets to aid in optimizing a specific transfer function, such as an objective function or a loss function. Accordingly, the circuits 112 and 114 are adapted as proxy models in an attempt to quantify and quantize human responses and behavioral aspects relating to empathy and circumstances, which can then, for example, be able to tune aspects representing personas or types of persons that are then utilized by the hypothesis engine 108 in tuning the empathic insights 116. The circumstance knowledge circuit 114 is utilized, for example, to establish that an individual's actions are not only guided by their emotional state, but also based on the factual information indicative of external factors or states that are available.

For example, a user's vehicle may be low on fuel, and this is tracked by a sensor coupled to the user's vehicle. From prior data sets and the trained models, it may be indicative that this triggers a direct experience aspect of the empathy circuit 112 where the user becomes anxious whenever the fuel is below a certain threshold. This direct experience could override other desires, and being driven by this particular model could be represented through an overweighting of the contribution from the direct experience aspect of the empathy circuit 112.

As shown in the pictographs on the top of FIG. 1A, empathic insights are generated through three aspects, a lightbulb representing a particular conjecture, factual information for a particular situation (e.g., environmental information), and empathic knowledge of the emotional state of an individual. Accordingly, insights can be delivered that are adapted for the best interests of the person as opposed to being self-serving for a particular company or objective.

An ensemble-based analysis is conducted by a processor of the hypothesis engine 108, and the hypothesis engine 108 receives as data inputs, the two tuning matrices 160 and 162 storing data representation of weight values from both an empathy-based machine learning mechanism and a circumstantial knowledge-based machine learning mechanism maintaining the corresponding models. When a new conjecture data object is generated representing a potential notification or an automatic action, the conjecture data object is processed to couple the conjecture data object with a number of circumstantial or empathy based relationships, generated, for example, using predictions from historic behaviour.

For example, a new conjecture data object could represent a notification that a vehicle's fuel level is becoming low, and that a certain refuelling station is along or proximate to the path of the individual returning home from work. The conjecture data object could be coupled with prior historical behaviour tracking to identify a set of circumstantial (e.g., weather) or empathy-based variables (e.g., anxiety levels) or factors which have impacted prior similar decisions.

The conjecture data object is then processed using the ensemble-based analysis to analyze the conjecture data object in view of the current situation's empathy-based tuning matrix weights 160 and circumstance-based tuning matrix weights 162, and an empathy-based conjecture score 166 is generated as an output. The empathy-based conjecture score is utilized to determine an empathic insight output 168, which, in some embodiments, can be controlled by a decision making interface 116 to include a notification or an automatic action.

In some embodiments, outcome feedback data sets 170 and 172 from whether an action was taken in respect of a notification or other types of responses occurred (e.g., notification acknowledged, dismissed, blocked) are tracked by, for example a payment processor 118, the feedback data sets 170 and 172 may then be utilized to re-tune the circumstance-based tuning matrix 162, or the empathy-based tuning matrix 160 and/or their corresponding machine learning models.

In a variation, the amount of privacy and available information may be tune-able by the user (e.g., using a controllable slider or knob) such that the system capabilities can be tuned based on the amount of information that is made available to the system. A trade-off between accuracy and availability of information/privacy is a consideration in the overall effectiveness of the system. However, such a feature is useful to provide user control over the amount of information to be exposed.

In another variation, a “virtual clean room”/trusted execution environment can be utilized to control access information, derivative information, and/or insights, for example, through controlling a data load and a data custodian aspect of any information or query to information stored on a coupled computer-readable storage. The trusted execution environment may operate on a secured/separated environment such that the environment is computationally isolated from other computing components and automatic privacy-enhancing mechanisms are used to enforce what information is available for access in conducting analyses.

In a further embodiment, the empathy-based machine learning models and/or the circumstance-based machine learning models are also hosted on and/or protected by the “virtual clean room”/trusted execution environment such that these models and their underlying interconnections cannot be directly accessed or queried to further enhance the privacy of the individual in respect of machine learning models that seek to emulate particular traits of an individual. In this example, the values and structures of the machine learning models is not accessible and instead, the machine learning models can only be interacted with to generate the specific tuning matrices.

FIG. 1B is an example block diagram illustrative of an operative computing ecosystem for the system of FIG. 1A, according to some embodiments.

In FIG. 1B, the system of FIG. 1A is provided as part of an overall personality based oracle mechanism 180 that uses the empathy-based approach for a global modelling approach to drive decision-making relating. The oracle mechanism 180 is a computer server that can reside in a data center or on distributed cloud resources that is configured to maintain models that pertain to specific users.

On the oracle mechanism 180, a global model 182 is provided that is stored, for example, on storage portion of a trusted execution environment, that pertains to each user. This can, for example, be associated with a unique identifier for that user, and the user can provide or indicate consent through tracked variables on the user's profile. If the user provides consent (or does not opt-out, depending on the embodiment), this global model 182 can be first trained and then accessed periodically. The global model 182 stores the empathy-based models 112, which each store a set of weights and scalars for a number of models.

The empathic circuits in the global model can take the form of ONNX or other machine learning model storage formats (e.g., export formats supported by SKLeatn, PyTorch, and/or TensorFlow). These can be deployed using a MLOps pipeline including but not limited to Amazon's AWS SageMaker, Microsoft's Azure ML, or systems using MLFlow, as examples.

A containerized distributed (private or public cloud for instance) environment is a potential deployment method and a microservice architecture for individual models and for all the coefficients is a preferred deployment architecture such that the services can be replaced. The models, upon receiving the feedback informed by the users' decisions can be updated in a batch process the cadence of which can vary depending on the empathic circuit itself and the specific automated business decision (or offer) at hand. Such can vary from minutes, or hours to days or months.

These circuits and corresponding models 112 may require secondary storage for their operations and for version control and they can utilize the S3 or similar protocols as realized on private or public clouds based on preference. Other traditional storage mechanisms can be used but are not the highest recommendations. More comprehensive solutions for model version control and experiment tracking may also be used such as SageMaker Model Registry, Weights & Biases and alike.

The empathy-based models 112 are configured to tracked for various empathy qualities in a human, which may or may not be mutually exclusive, such as having a set of cooperating models specifically for tracking a human's proclivity to exploring new pathways, another for tracking the human's openness to listening to information be presented before them, another tracking the human's tendency to follow prior direct experiences, among others.

These models can be trained on a per-user basis, and once trained, can be continuously updated, periodically updated, or permanently set, depending on the embodiment.

In some embodiments, the system is primed with a diverse set of “default personas” reflective of the users in the environment into which the solution is being deployed. A newly added user, who does not have a persona in the system, can be assigned a “best fit” default persona based on data that is available about the user, thus establishing an Empathy Baseline for the persona (the empathy model is part of the persona definition).

When a person is introduced into the system, they are assigned a newly instantiated model 112, which, can be instantiated with base values (e.g., 0.5, 0.5, 0.5, 0.5), random values, or values that are based on an initial rough demographic classification (e.g., Rohin is a young Gen-Z age group student at the local college, and their demographic average/median is represented as 0.2, 0.4, 0.6, 0.1, 0.8, where the base empathy circuits show that students are curious, open to exploring, but have little patience).

The system will recommend the user subsequently further tune their persona through a specialized interactive experience used to better qualify the empathy baseline empathy model. This interactive experience can be a set of Q&A designed to surface the underlying empathy characteristics of the user. The Q&A format can be configured such that there is no wrong answer, rather answers to questions will surface underlying empathy basis. As the system is used the empathy model is regularly refined based on feedback as the user interacts with system.

In other variations, the tuning of the persona continues as, if the user consents, the user has various other interactions with other components that are coupled to the oracle system. For example, these interactions can include interactions with chatbots, online banking interfaces, mobile applications, purchase transactions, etc., and the interactions can be recorded in the form of state-action pairs, and these can be used as objective measures of various empathetic states for tuning the model and establishing the user's baseline persona.

In further embodiments, the recorded interactions or recorded Q&A questions are also coupled with temporally proximate circumstantial information during or around the time that they occur, and these can also be used as state action pairs to simultaneously or separately train the machine learning models used to generate the biasing weights in relation to the circumstantial information.

Using demographically instantiated models as a starting point is useful as, in some cases, the tuning required may be reduced, especially if the person's persona is close to the empathic characteristics of the demographic model. Accordingly, in some embodiments, the oracle system 180 is further configured to periodically generate average or median profiles of particular demographic groups in an attempt to improve a speed of training and learning whenever a new person is being added to the system.

The model 182 is updated periodically through received signals from data sets obtained from other tracked interactions, and these can be used to tune the weights. Inputs for generating a persona model can, for example, be obtained from tracked records or on-going interactions with external sources, such as chat bot dialogue flows, voice inflections during calls, tracked website interactions or computer input movements. Other information can include biological data during these interactions, such as biorhythms, video feeds, etc. These inputs can be provided, for example, as governed by express consent for model personalization. Consent can be tracked using a consent tracker mechanism, which, in some cases, can include a data storage that checks, for each user or each element of information stored thereon or being used for training, that consent was provided before using it for model training or updating by a model updater mechanism. The model updater mechanism can be a daemon or other computational process that takes recorded values of interactions as action-value pairs to update the model 182.

An example tracked interaction can include, for example, a person traversing through an online banking mobile application on their device. Data and metadata associated with the user's traversals can be utilized and extracted to obtain inputs into the model and the model can recognize useful patterns in the data for downstream system use.

These characteristics can include, for example, linger periods on each page (e.g., 300 ms, 800 ms, 5 seconds), how quickly the user scrolls through text such as terms of use pages (e.g., 3 lines/second, terms of use skipped to the bottom), items they tap on, and their sequential patterns how many pages of information values or interest rates were examined before coming to a decision, for example.

Another example of such characteristics can include those obtained from recorded chats over the phone or through a web chat service, and these can include both raw information such as the tracked cadence of speech (e.g., 4.5 syllables per second), or derived information, such as a machine learning based intention determination from the speech pattern (e.g., dialog model estimates the user is annoyed). All of these information elements can be used in respect of models that represent, for example, a level of curiosity levels (e.g., how much research a user conducts or how much variety there is in the different services used or pages traversed), a level of listening/not listening (e.g., low patience levels can be associated with not listening), among others.

After training, the underlying data is not required to be stored, and thus once the data is used for training, it can be discarded or removed. Further, in a variation, the underlying data for training can be perturbed or noise can be injected to add a level of “fuzz” to the trained models to further reduce a possibility of reverse engineering. The fuzz, for example, can be added through using a pseudo random number generator that perturbs the data before being used for training.

The system is adapted in an attempt to computationally “evolve” to model various aspects of empathy (including by not limited to: curiosity, preconception, inspiration, listening, imagination, etc.) and as such provides a framework to include these models and factor in their outputs in order to enhance decision making that incorporates holistic empathic consideration when engaging consumers in real-time in path to their journeys; helping to make decisions or surface opportunities. Each aspect of empathy is modeled as an Empathy Circuit and is given a weight that is derived from the baseline empathy model of the user.

The following provides an example of the system at work.

An external system creates a Prediction that Gurinder will eat lunch within the next 60 minutes with 90% confidence. The Hypothesis engine has been primed with tens of thousands of merchant offers and promotions that could be sent to Gurinder, but they will not be sent until the system initiates a offer process and picks the best subset of offers to send Gurinder for the given circumstance.

Gurinder's baseline Empathy Model is currently set at {curiosity=0.434, imagination=0.23, listening=0.789, inspiration=0.54, preconception=0.89}.

Each of the offers is corresponding configured relative to Circumstance and Empathy factors. An offer for FastFoodBrand1 for example can have Empathy relevance factors set to {curiosity=High, imagination=Low, listening=High} whereas an offer from FastFoodBrand2 may have {curiosity=Low, imagination=High, Listening=Low}. These factors are representative of the content consumption requirements of the media proposed to be sent to Gurinder.

Furthermore, the offers will also have Circumstance factors to consider. The FastFoodBrand1 offer may have {location=within 1000 meters of a restaurant, time=after 2:00 pm} while FastFoodBrand2's could have no circumstance considerations.

The hypothesis engine 108 (Itself an AI model) will synthesize the inputs to establish the most relevant offer to send to Gurinder. The hypothesis engine 108 will have been trained on the parameters associated with Empathic Inputs, Offer configuration, Circumstance inputs in order to establish the best offer (if any) to send to Gurinder in that moment, based on the initial conjecture.

The hypothesis engine 108 is additionally trained to environmental and physical traits and as such will magnify the baseline empathy model. To elaborate, the hypothesis engine 108 is trained on IoT data feeds that establish the current empathic state, such as facial expressions, body posture, blood pressure, blood sugar levels, to name a few.

When Gurinder receives the offer, his actions as he navigates the offer will be collected and feed back into the system to further refine Gurinder empathy model.

Each of these models can be initialized to have pre-defined weightings or random weightings, and as part of the training process, these weightings can be updated and refined based on iterating the model to optimize a loss function using the person's past activities and provided preferences as ground truth for training.

An outcome from training can include a representative set of scalars for machine learning parameters that together define the latent or hypothesis space for a particular empathy-based aspect of a person's personality, and these values or vectors can then be used as a simplified representation for downstream usage.

Accordingly, the models, once trained, represent the person's base tendencies (e.g., Rohin is a naturally a very curious individual who enjoys trying new things, but has a tendency to prefer relying on his direct experiences rather than listening to information provided by others). Rohin's base empathy is now modelled and stored as a computer-based representation that is can be used for further individualized machine learning tuning.

Rohin's empathy model after training is represented as a set of scalar values. Each of the values (a, b, c, d) is a weight used to establish Rohin's correlation to specific empathy circuits. The scalar notion of the training output is purposefully mathematically simplified in order to support quick computations in large-scale deployments. [a=curiosity, b=imagination, c=inspiration, d=listen]

Where there are a plurality of different empathy based models, each of these models can be coupled with a biasing factor that is modifiable based on the specific circumstances upon which one is making a decision in a particular moment in time. These circumstantial factors can include, for example, tracked external characteristics, such as weather (e.g., temperature, precipitation), vehicle speed, among others.

Data and Information to be used by the entirety of the proposed system can be gathered via an open class heterogeneous set of channels. This is governed by user consent. This includes various edge devices, including but not limited to, various types of sensors in electronics or vehicles. All the inputs can be properly protected by encryption at rest and in transit and data or metadata will move minimally and only if need be.

Depending on the privacy configurations of the project a significant portion of the computation can stay on the edge devices minimizing the need to transfer raw data back to the central. The gathered data will be used to train and update machine learning models, inform the knowledge bases storing facts and any temporary or permanent storage mechanisms concerning circumstances within the central environment.

The combination of the 3 (models, facts, and circumstances) together with the available offers are merged in the environment (e.g., private and/or public cloud) and turned into insights by the hypothesis engine 108.

These circumstantial considerations are then used to provide inputs that are refined and transformed into biasing weights that modify the weighted contribution from each of the empathy-based models, and the overall contribution of a large number of circumstantial considerations can thus be utilized to transform the computational impact of the empathy-based models.

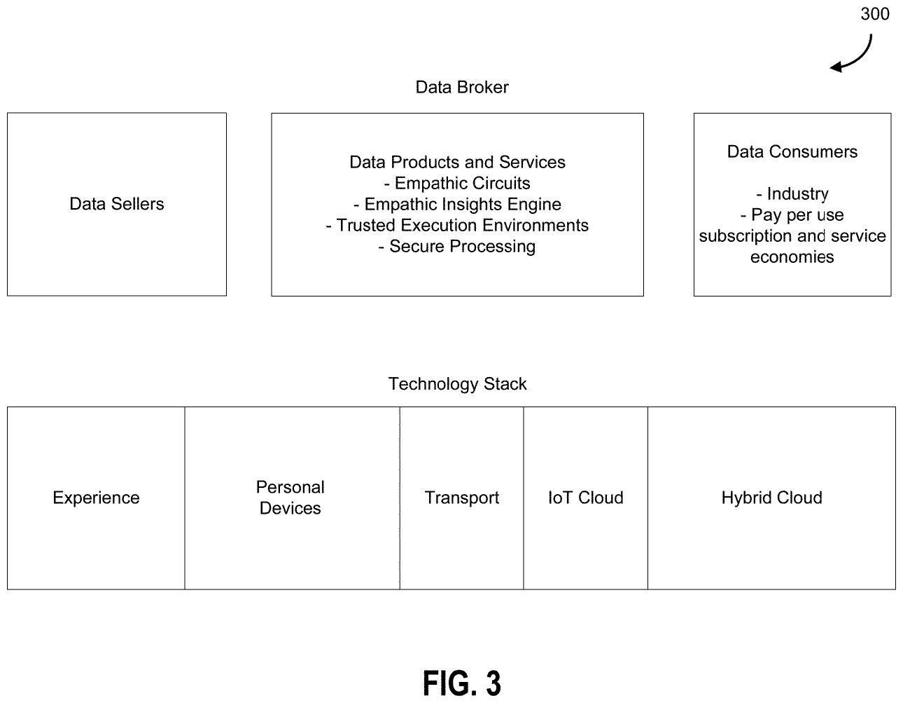

Referring to FIG. 3, the information can be obtained from different devices, such as IoT cloud devices, transportation devices, personal devices, among others. In some embodiments, the circumstantial data may also be obtained from different data marketplaces, among others.

The circumstantial data is utilized to tune the weightings associated with the base empathy model, and in the example of Rohin's empathy model, it may be that while Rohin is very curious as a base state, when Rohin is in a rush (e.g., as evidenced by his vehicle speed), the model may indicate that he is instead driven very much by direct experience and tunes the empathy model so that the direct experience becomes the dominant empathy model (through modifying the weighted contribution) for Rohin in these circumstances.

For example, while Rohin's base empathy value for listening based on the listening model is 0.7 after training, the circumstantial data may generate a tuning matrix where the weighting contribution of the listening model is applied at 0.8, so 0.7*0.8=0.56, reducing the impact of the listening model. On the other hand, the direct experience model is modified by a factor of 1.5, etc. An approach for tuning the impact of various circumstantial factors to generate the tuning matrices 162 can be through the usage of machine learning models that utilize feedback based on tracked outcomes 118 to optimize a particular loss function or target outcome. The circumstantial factors can be measured, for example, as a relative deviation from an established target, average or a median that can be predefined or dynamically defined. For example, the circumstantial input can include a deviation from a base temperature, a deviation from a speed limit (posted or average). Because Rohin is driving at 45 mph, which is 2.5 mph greater than the tracked average user speed for a particular road, that could be an example circumstantial input. This can be compared with inputs from Rohin's calendar information, which indicates that he is approximately 15 minutes away from his next meeting and still travelling there. However, Rohin's last food transaction was over 24 hours ago.

A conjecture object may be triggered nonetheless in an attempt to show Rohin a useful notification or to provide Rohin with a useful offer. However, Rohin, in the past, changes his empathetic qualities significantly when he is in a rush, and this is reflected in the biasing weights as generated based on the circumstantial information pairs used to train the circumstantial knowledge machine learning models. The biasing weights reflect that his empathetic qualities of seeking basis in prior experiences is magnified, while his empathetic qualities of exploration and curiosity are reduced.

Accordingly, when the conjecture surfaces and parameters of the notification are controlled, the system is biased towards showing Rohin in-path offers for fast food biased towards restaurants he has had interactions with before (e.g., he has had direct experiences with), and even the user interface elements for presentment are simplified as he has a lower propensity for listening (e.g., large fonts, minimal text, high contrast graphical icons, centrally located near the main notification area).

As another factor for contribution into the overall impact from the empathic model, Rohin may also be more open to exploration when the weather is nice (e.g., temperature >75 degrees Fahrenheit) and it has a corresponding effect on his mood. Both of these factors would then have countervailing effects on the contribution, and a weighted contribution could take into account both of these factors together. This example is simplified, and there can be a large number of factors being considered as part of a practical implementation. As a result of the circumstantial knowledge and thus circumstantial factors available at the time of a machine learning decision being made, a tuning matrix can be generated that changes the bias weights of the empathy-based modelling.

In some embodiments, the offer amount may also be modified depending on the campaign characteristics defined in the conjecture object.

Each variation of parameters can be considered a different candidate insight data objects representing potential computer-based interactive notifications, from which the system ultimately selects a single candidate insight data object for presentment.

For example, different variations can include:

Candidate data object 1: Advertisement for FastFoodBrand1, offer is 10% off, notification type=badge, notification size=40 pixels, notification location=0,0, notification effect=blinking, notification timing=when user is within 3 km range

Candidate data object 2: Advertisement for FastFoodBrand2, offer is 10% off, notification type=badge, notification size=40 pixels, notification location=10,5, notification effect=blinking, notification timing=when user is within 3 km range

Candidate data object 3: Advertisement for FastFoodBrand1, offer is 15% off, notification type=banner, notification size=60 pixels, notification location=210,210, notification effect=transparent, notification timing=when user is within 1.5 km range

Candidate data object 4: Advertisement for FastFoodBrand3, offer is 0% off, notification type=lock screen, notification size=60 pixels, notification location=20,20, notification effect=solid, notification timing=when user is within 1.5 km range

Candidate data object 5: Advertisement for VacationBrand1 in Mexico, offer is 15% off, notification type=lock screen, notification size=120 pixels, notification location=20,20, notification effect=tropical motif, notification timing=when user is at home

There can be hundreds or thousands of candidate data objects for the system to choose from, and the above are shown as examples. The system can ultimately assign scores to each by processing them using at least the modified empathy scores as an additional signal into one or more machine learning models, and select the candidate data object having the highest overall score.

A machine learning model can be employed as a decision making matrix to configure first, whether or when notification should be shown to Rohin, then, for example, the specific content of the notification, and/or how the notification should be surfaced in a way that provides maximized utility for Rohin. The feedback information provided back for additional reinforcement learning or supervised learning can include, for example, a matrix of information, including outcome information, notification content, notification size, color, opacity, when the notification was generated, etc. Feedback information can be obtained, for example, from the parameters of the candidate data object that was surfaced.

Utility and interaction can be measured in terms of feedback to the machine learning model to re-tune various characteristics based on actions taken by Rohin. For example, Rohin interacting (instead of ignoring) with the notification may indicate that a particular method of controlling the user interface was effective, and depending on the specific outcome of the interaction (e.g., uses it positively or dismisses it negatively), that can be used to tune which notification to be shown, or whether a notification should be shown at all (or suppressed).

The decision making matrix can be a machine learning model that takes, as only part of the decision making matrix, the input signal from the empathy-based models, as biased by the weighting factors from a tuning matrix established by circumstantial information.

The approach described herein accordingly provides a computational mechanism to improve relevance and resiliency of computer based decision making as it relates to specific empathy-driven personality aspects of a person.

These factors are computationally useful inputs in tailoring machine outputs and decisions based on modelled personality traits, as opposed to relying only on factual decision making. This is useful, for example, as while the same facts may be true for all people in a particular area (e.g., the temperature is 80 degrees Fahrenheit), each person experiences this differently (e.g., some enjoy the warmth, while for others they begin to have increased anxiety or a decreased level of patience).

FIG. 2 is an example equation showing a relation for an empathic insight, according to some embodiments. In the equation 200, a conjecture score can be associated with a particular conjecture associated with a candidate empathic insight, and the conjecture score can be a summation of predictions whereby the tuning matrices 160 and 162 are utilized to establish the summed prediction score. The conjecture score can be used in different ways by the system. For example, the conjecture score can be utilized to determine an empathic insight output, which, in some embodiments, can include a notification or an automatic action.

FIG. 3 is a computer architecture block schematic diagram showing an example computing architecture 300 that can be utilized to provide a computing ecosystem for the empathic circuits, according to some embodiments. As shown in FIG. 3, there are a number of different coupled systems that can be used as sources of empathic information for training the machine learning models, as sources of circumstantial information which can be used for both training the machine learning models and obtained at run-time for generating bias weights to modify the contributions from the various empathic models.

In some embodiments, the information can be tracked as part of a data broker/data marketplace, where with the user's consent, the empathic information or other information and/or access to the models can be used for campaign generation and/or analysis. For example, FastFoodBrand1 may wish to analyze how to best target an ad or offer for maximum effectiveness and utility for users.

If the users have given consent (and/or are compensated for doing so), analyses can be conducted, for example, showing that FastFoodBrand1 is most effective at having positive interactions with their ads when they are in-path, and in alignment with users having the modified empathetic state in specific circumstances that yield the modified empathetic states.

Accordingly, FastFoodBrand1 can further tune their conjecture data object definitions during a marketing campaign definition phase to further increase a specificity of audience targeting. If FastFoodBrand1 has a limited number of offers for a new type of food product for example, FastFoodBrand1 can establish that the best FastFoodBrand1 in-path offers shown on graphical user interfaces on navigation applications should be targeted towards people who have a curious but low patience modified empathy state. This would be more useful than simply trying to target people who are in a rush (without taking into account their empathetic states). Similarly, trying to target people using just the baseline empathy states fails to take into account their modified empathetic states due to external factors, such as weather, time to next meeting, etc., and may be less effective.

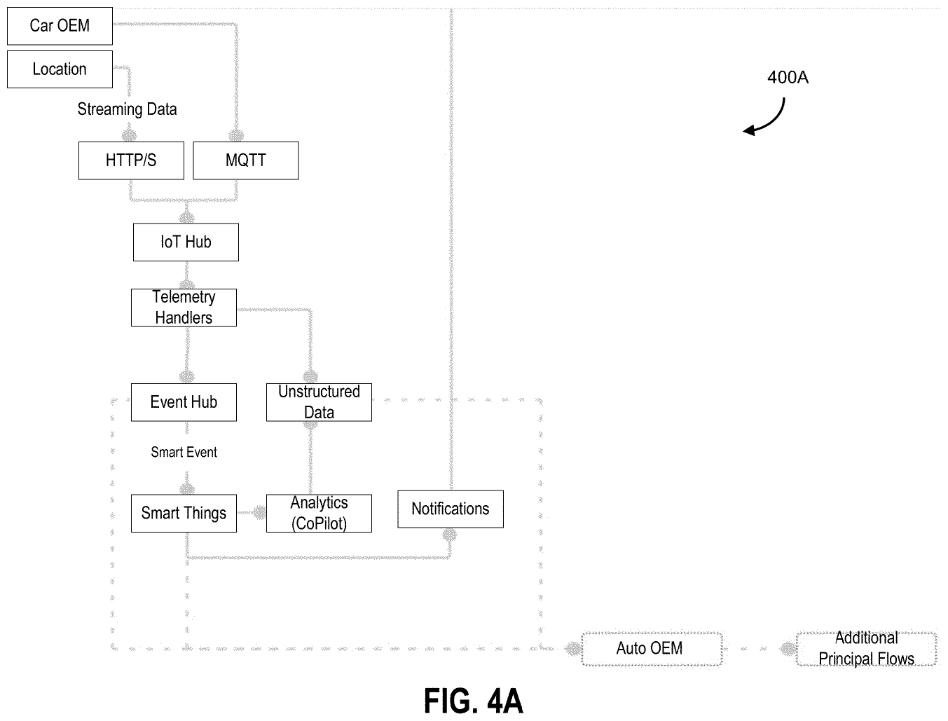

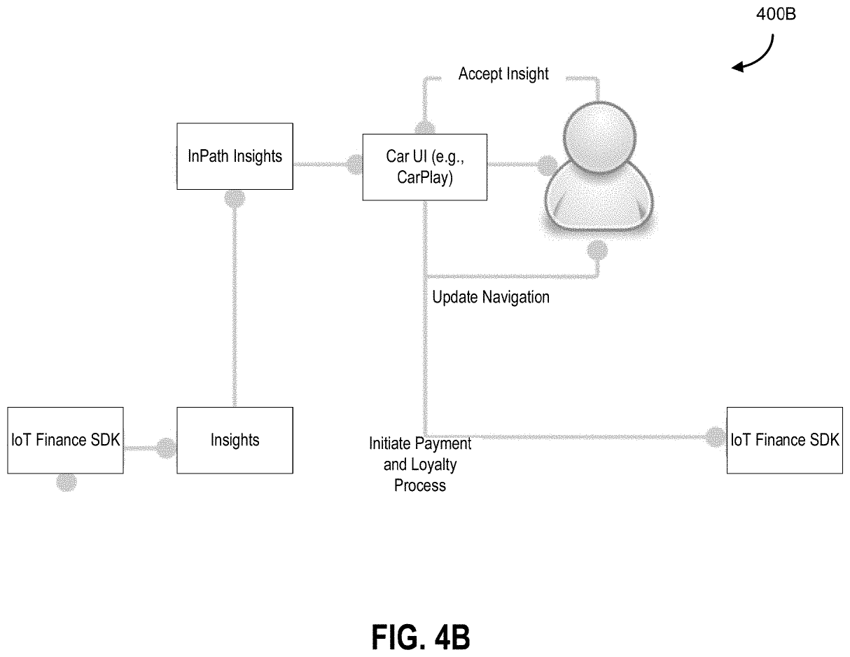

FIG. 4A is a process diagram illustrative of a method where the empathic circuits are utilized in an automotive context, according to some embodiments.

In FIG. 4A, the method 400A shows a circumstantial feedback loop that can be sensed based on environmental conditions. For example, the individual may be driving through a particular type of area (e.g., high crime, rural, on the way to work), and these can be utilized as feature inputs into a machine learning model. In some embodiments, there are a large number of feature inputs, an additional pre-processing step may be utilized to identify a subset of those feature inputs (e.g., input streams) that are meaningful to reduce computational overload. An empathic insight can be generated using a combination of these factors combined with inputs from a model representing the user's empathic qualities.

FIG. 4B is a process diagram illustrative of a method where the empathic circuits obtain feedback for updating empathic circuits in an automotive context, according to some embodiments. In the method 400B, a user may choose to accept an insight or reject an insight, and this can be utilized as feedback into the system to re-tune or re-model the empathic or circumstantial circuits.

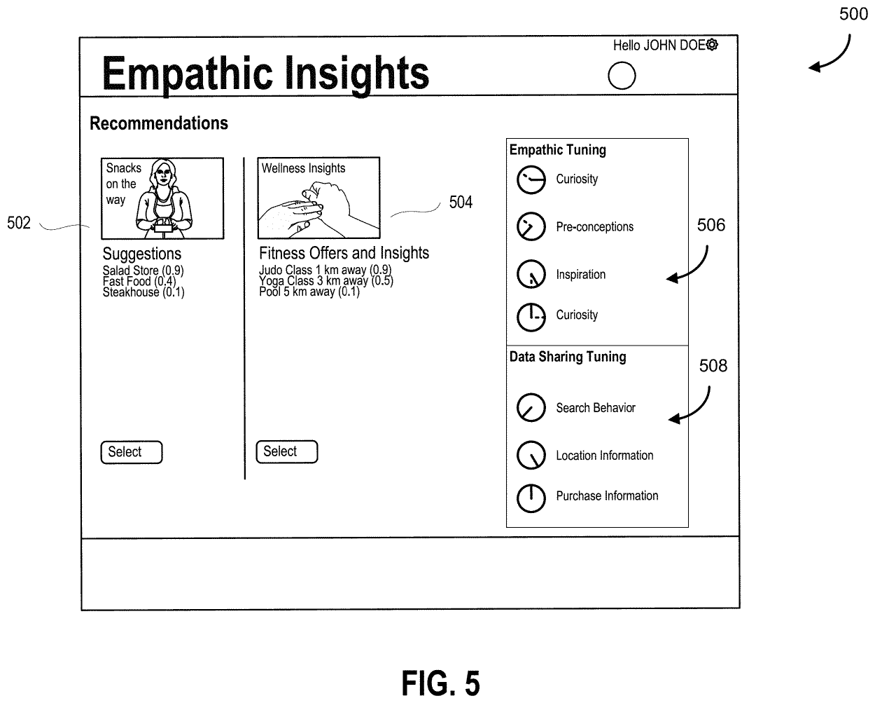

FIG. 5 is an example rendering of a graphical user interface (GUI), according to some embodiments. In FIG. 5, the GUI 500 is provided to a user so that the user is able to see a set of provided suggested candidate empathic insights, in this example, food recommendations 502 and wellness recommendations 504. The candidate insights can be ranked based on determined conjecture scores, which can use a combination of trained model outputs relating to empathy combined with the trained model outputs relating to circumstances.

In some embodiments, the GUI 500 also provides adjustable tuning knobs 506 or interactive control elements where a user is able to re-weight certain model features relating to the empathy circuits and change the behavior of the system, for example, by changing a tuning of the importance of the curiosity circuit, the pre-conceptions circuit, etc. When a re-tuning occurs, a new tuning model may be generated and the conjecture scores can also be re-generated to re-rank and re-weight the candidate empathic insights. The user, effectively, can take control of their empathy circuits 112 and change their baseline persona, if desired.

A set of tuning control elements 508 may also be provided for controlling a level of data sharing through a set of interactive control elements, which modify a level of data to be shared or provided into the system as inputs into the models. For example, there can be different levels of data collection that are available, which can impact the accuracy of the system. However, the user is free to turn off or disable these features to improve a level of desired privacy.

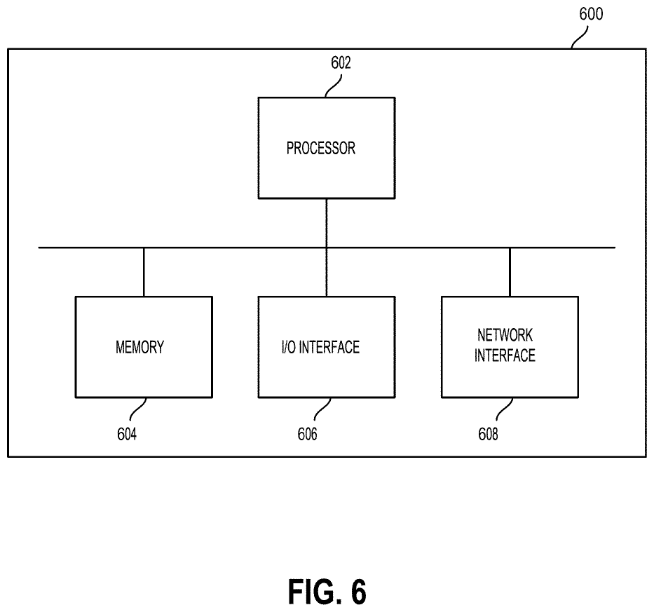

FIG. 6 is an example block schematic of a computing system, according to some embodiments. The computing system 600 is a computer server that is configured to provide an empathic insights engine, and can include computer processor 602 that operates in conjunction with computer memory 604, an input/output interface (e.g., touch input) 606, and a network interface 608.

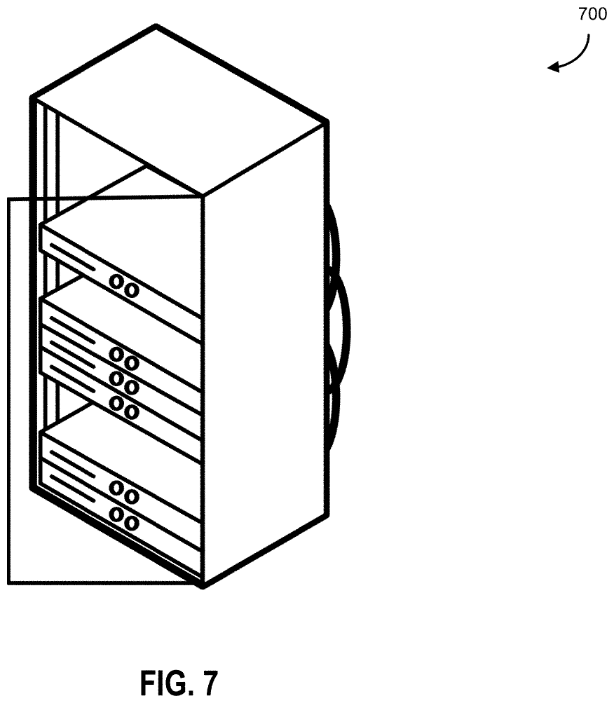

FIG. 7 is an example computer server for generating empathic insights, illustrative of simulation results, according to some embodiments. The computer server 700 shown can be a special purpose machine that is positioned, coupled to, or resides within a data center, and for example, can be a rack mounted computing appliance coupled to a message bus that receives data messages indicative of environmental conditions and sensory inputs. The computer server 700 maintains the computational model representations of the empathic circuit and the circumstantial circuit, and is configured to generate output conjecture scores for coupling to candidate empathic insights.

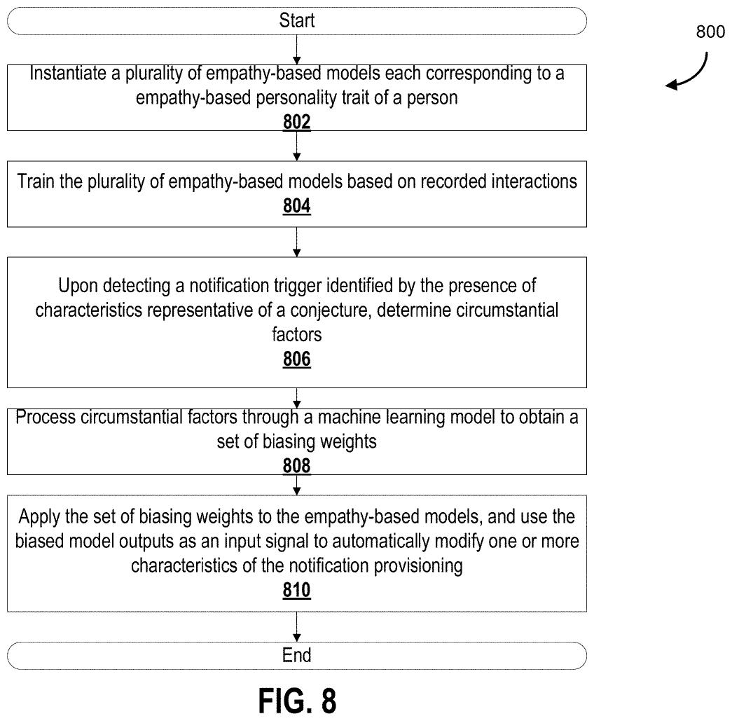

FIG. 8 is an example method diagram showing an example process approach for using empathic insights in machine learning, according to some embodiments. In example method 800, at step 802, the process begins by instantiating a plurality of empathy-based models each corresponding to an empathy-based personality trait of a person. As noted above, these models can be stored on a global oracle database or data storage, and the values for instantiation can be boot-strapped by using values that are based at least on an initial demographic classification of the person, which can then be tuned at 804 as the system is configured to train the plurality of empathy-based models based on recorded interactions. This empathy-based model can be used as a baseline for the person in normal circumstances.

At 806, upon detecting a notification trigger identified by the presence of characteristics representative of a conjecture, the system is configured to determine circumstantial factors. A conjecture can be defined as a data object for a notification based on a defined campaign, such as a triggering for when a notification for an advertisement for a fast food item is queued for surfacing to the user.

The circumstantial factors can be obtained for the specific point in time—for example, temperature, vehicle speed, etc.

The conjecture can include a plurality of options for how the notification is shown, and these can be represented as tunable characteristics of the notification. These can include, for example, whether the notification is shown at all, when the notification is shown, the content of the notification (e.g., which fast food restaurant to show, fast food restaurants of what locations to show), and/or how the notification is shown in respect of tunable interactive graphical user interface element characteristics (e.g., size of window, color, additional effects such as animations), or different notification types (e.g., badges, icons, banners).

At 808, the circumstantial factors are processed through a machine learning model to obtain a set of biasing weights, which impart modifications to the empathic baseline, effectively modelling the person in modified circumstances. This is useful because it allows the system to modify how the specific person reacts emotionally to a particular change in circumstance. For example, certain people, when the temperature is high, will be in a bad mood and will resort to relying more on their prior experiences and be less open to new experiences, and other people, when the temperature is high, will be in a great mood and be more open to exploring new experiences and/or more receptive to listening to more complex advertisements or offers.

At 810, the system is configured to apply the set of biasing weights to the empathy-based models, and use the biased model outputs as an input signal to automatically modify one or more characteristics of the notification provisioning. These characteristics that can be modified can include whether a notification is shown at all, when it is shown, what the content of the notification is, etc. For example, depending on the biasing weights, the biasing weights could indicate that the user is in a rush and more likely to select something from a past direct experience, biasing a decision towards showing a fast food restaurant that the user has transacted at many times in the past (showing past prior experiences). On the other hand, the biasing weights for a particular point in time may indicate that the user feels particularly comfortable and is open to a more complex advertisement in respect of a sunny beach vacation.

The modification of the one or more characteristics of the notification provisioning in a further embodiment can include validation against desired persona traits for a particular notification or offer type that are defined during campaign creation or audience generation for the targeting of a particular offer. Such an approach aids in the improved targeting by an advertiser. For example, an advertiser seeking to advertise a sunny vacation could limit their best offer or notification to be shown only for those people having a modified empathy score for their inspiration-based empathy model at 0.8 and above.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A system for controlling generation of one or more computer-generated insights using empathy-based machine learning features, the system comprising:
a processor, operating in conjunction with computer memory and data storage, the processor configured to:
maintain, in a first set of machine learning models each tracking an empathy-based aspect of a user, a trained empathy based representation of the user, each of the machine learning models of the first set of machine learning models tracking a different empathy-based aspect of the user;
maintain, in a second machine learning model, a trained circumstance based representation of the user;
receive one or more candidate insight data objects representing potential computer-based interactive notifications;
generate a tuning matrix from the second machine learning model to be applied as biasing weights to the trained empathy based representation of the user;
process each of the one or more candidate insight data objects using at least the biasing weights applied to the trained empathy based representation of the user to generate a real-time prediction score for each of the one or more candidate insight data objects; and
transmit the candidate insight data object having a highest score to a user interface associated with the user.

2. The system of claim 1, wherein the processor is further configured to:
receive, from the user interface associated with the user, a data set representative of an outcome associated with presentation of the candidate insight data object to the user; and
re-train the first set of machine learning models and the second machine learning model using the data set representative of the outcome associated with presentation of the candidate insight data object to the user.

3. The system of claim 1, wherein the empathy-based aspects include at least one of curiosity, preconceptions, inspirations, direct experience, listening, or imagination.

4. The system of claim 3, wherein each of the different machine learning models of the first set of machine learning models are associated with a separate model weighting, and wherein the user interface includes interactive control elements which are configured to receive user inputs modifying the model weightings such that the first tuning matrix can be changed based on different weights applied to the different machine learning models of the first set of machine learning models.

5. The system of claim 1, wherein the second machine learning model is configured to track environmental features associated with a particular contextual environment of the user.

6. The system of claim 5, wherein the environmental features include at least time, weather, and location of the user.

7. The system of claim 6, wherein the location of the user further includes a determination of whether the user is currently in transit.

8. The system of claim 7, wherein the determination of whether the user is currently in transit includes obtaining additional features associated with a vehicle in which the user is currently in transit.

9. The system of claim 2, wherein the data set representative of the outcome includes interactions on the user interface associated with the notification.

10. The system of claim 1, wherein the data set representative of the outcome includes payment interactions associated with the notification.

11. A method for controlling generation of one or more computer-generated insights using empathy-based machine learning features, the method comprising:
maintaining, in a first set of machine learning models each tracking an empathy-based aspect of a user, a trained empathy based representation of the user, each of the machine learning models of the first set of machine learning models tracking a different empathy-based aspect of the user;
maintaining, in a second machine learning model, a trained circumstance based representation of the user;
receiving one or more candidate insight data objects representing potential computer-based interactive notifications;
generating a tuning matrix from the second machine learning model to be applied as biasing weights to the trained empathy based representation of the user;
processing each of the one or more candidate insight data objects using at least the biasing weights applied to the trained empathy based representation of the user to generate a real-time prediction score for each of the one or more candidate insight data objects; and
transmitting the candidate insight data object having a highest score to a user interface associated with the user.

12. The method of claim 11, comprising:
receiving, from the user interface associated with the user, a data set representative of an outcome associated with presentation of the candidate insight data object to the user; and
re-training the first set of machine learning models and the second machine learning model using the data set representative of the outcome associated with presentation of the candidate insight data object to the user.

13. The method of claim 11, wherein the empathy-based aspects include at least one of curiosity, preconceptions, inspirations, direct experience, listening, or imagination.

14. The method of claim 13, wherein each of the different machine learning models of the first set of machine learning models are associated with a separate model weighting, and wherein the user interface includes interactive control elements which are configured to receive user inputs modifying the model weightings such that the first tuning matrix can be changed based on different weights applied to the different machine learning models of the first set of machine learning models.

15. The method of claim 11, wherein the second machine learning model is configured to track environmental features associated with a particular contextual environment of the user.

16. The method of claim 15, wherein the environmental features include at least time, weather, and location of the user.

17. The method of claim 16, wherein the location of the user further includes a determination of whether the user is currently in transit.

18. The method of claim 17, wherein the determination of whether the user is currently in transit includes obtaining additional features associated with a vehicle in which the user is currently in transit.

19. The method of claim 12, wherein the data set representative of the outcome includes interactions on the user interface associated with the notification.

20. A non-transitory computer readable medium storing machine interpretable instruction sets, which when executed by a processor, cause the processor to perform a method for controlling generation of one or more computer-generated insights using empathy-based machine learning features, the method comprising:
maintaining, in a first set of machine learning models each tracking an empathy-based aspect of a user, a trained empathy based representation of the user, each of the machine learning models of the first set of machine learning models tracking a different empathy-based aspect of the user;
maintaining, in a second machine learning model, a trained circumstance based representation of the user;
receiving one or more candidate insight data objects representing potential computer-based interactive notifications;
generating a tuning matrix from the second machine learning model to be applied as biasing weights to the trained empathy based representation of the user; and
processing each of the one or more candidate insight data objects using at least the biasing weights applied to the trained empathy based representation of the user to generate a real-time prediction score for each of the one or more candidate insight data objects; and transmitting the candidate insight data object having a highest score to a user interface associated with the user.
